(19) United States
(12) Patent Application Publication
(10) Pub. No.: US 2017/0235521 A1
(43) Pub. Date: Aug. 17, 2017

(54) DISK STORAGE APPARATUS AND ACCESS CONTROLLING METHOD

(71) Applicant: Kabushiki Kaisha Toshiba, Tokyo (JP)

(72) Inventors: Yuka Kuwano, Yokohama Kanagawa (JP); Hidekazu Masuyama, Kawasaki Kanagawa (JP); Takato Kuji, Yokohama Kanagawa (JP); Kimiyasu Aida, Kawasaki Kanagawa (JP); Kenji Inoue, Kamakura Kanagawa (JP)

(21) Appl. No.: 15/259,385

(22) Filed: Sep. 8, 2016

Related U.S. Application Data
(60) Provisional application No. 62/294,393, filed on Feb. 12, 2016.

(51) Int. Cl. G06F 3/06; G11B 20/12

(52) U.S. Cl. CPC G06F 3/0659; G06F 3/0611; G06F 3/0676; G11B 20/1217; G11B 2020/1241

(57) ABSTRACT

According to one embodiment, a data storage apparatus includes a storage media and a controller. The controller is configured to execute a first process of reading or writing user data from or to the disk storage media which includes a plurality of recording areas, in accordance with a command requested via the host interface, the command including address information that are capable of specifying a recording area; to recognize a first area in which no user data is written, in a case of executing a second process different from the first process on the plurality of recording areas, without designating address information that are capable of specifying a recording area; and to execute the second process on a second area in which user data is written excluding the first area among the plurality of recording areas.

### CROSS-REFERENCE TO RELATED APPLICATIONS

This application claims the benefit of U.S. Provisional Application No. 62/294,393, filed Feb. 12, 2016, the entire contents of which are incorporated herein by reference.

### FIELD

Embodiments described herein relate generally to a disk storage apparatus and an access controlling method.

### BACKGROUND

In general, a disk storage apparatus, such as a hard disk drive (HDD), reads or writes data from or to a disk that is a storage media, in accordance with a command (read command or write command) from a host.

The disk storage apparatus executes, while not executing a command from the host, a process for securing reliability of all user data on the disk. In addition, the disk storage apparatus executes formatting, other than a read process or a write process that is a main process. For the purpose of convenience, these processes are expressed as “utilities processing”. Specifically, the utilities processing includes, for example, an Adjacent Track Interference (ATI) scan process, a Background Media Scan (BMS) process, and a Drive Self-Test (DST) process. In other words, the utilities processing corresponds to a background process, in contrast with the read process or write process that is the main process.

In general, the utilities processing is executed on all user data on the disk as a target range. Specifically, the utilities processing requires, in general, a considerable length of time from the start to the end, since the utilities processing executes a disk access control to access (or scan) the entire surface of the disk, without specifying logical addresses (LBA).

The reliability of data is enhanced in accordance with an increase of the processing time of the utilities processing. However, on the other hand, the increase of the processing time of the utilities processing leads to one of factors that cause a decrease in performance of a data input/output process corresponding to the execution of a command from the host.

Therefore, in the disk storage apparatus, in order to improve the performance of the input/output process, it is required to realize enhancement in efficiency of the utilities processing.

### BRIEF DESCRIPTION OF THE DRAWINGS

FIG. 1 is a block diagram for describing a configuration of a hard disk drive according to embodiments;

FIG. 2 is a flowchart for describing a write process according to a first embodiment;

FIG. 3 is a figure for describing a table that is used in utilities processing according to the first embodiment;

FIG. 4 is a flowchart for describing the utilities processing according to the first embodiment;

FIG. 5 is a flowchart for describing a read process according to the first embodiment;

FIG. 6 is a flowchart for describing a write process according to a second embodiment;

FIG. 7A and FIG. 7B are figures for describing states of a user data area on a disk according to the second embodiment;

FIG. 8 is a flowchart for describing utilities processing according to the second embodiment; and

FIG. 9 is a flowchart for describing a read process according to the second embodiment.

### DETAILED DESCRIPTION

Various embodiments will be described hereinafter with reference to the accompanying drawings.

According to one embodiment, a data storage apparatus includes a storage media and a controller including a host interface circuit and a processor. The controller is configured to execute a first process of reading or writing user data from or to the disk storage media which includes a plurality of recording areas, in accordance with a command requested via the host interface, the command including address information that are capable of specifying a recording area; to recognize a first area in which no user data is written, in a case of executing a second process different from the first process on the plurality of recording areas, without designating address information that are capable of specifying a recording area; and to execute the second process on a second area in which user data is written excluding the first area among the plurality of recording areas.

[Configuration of Disk Drive]

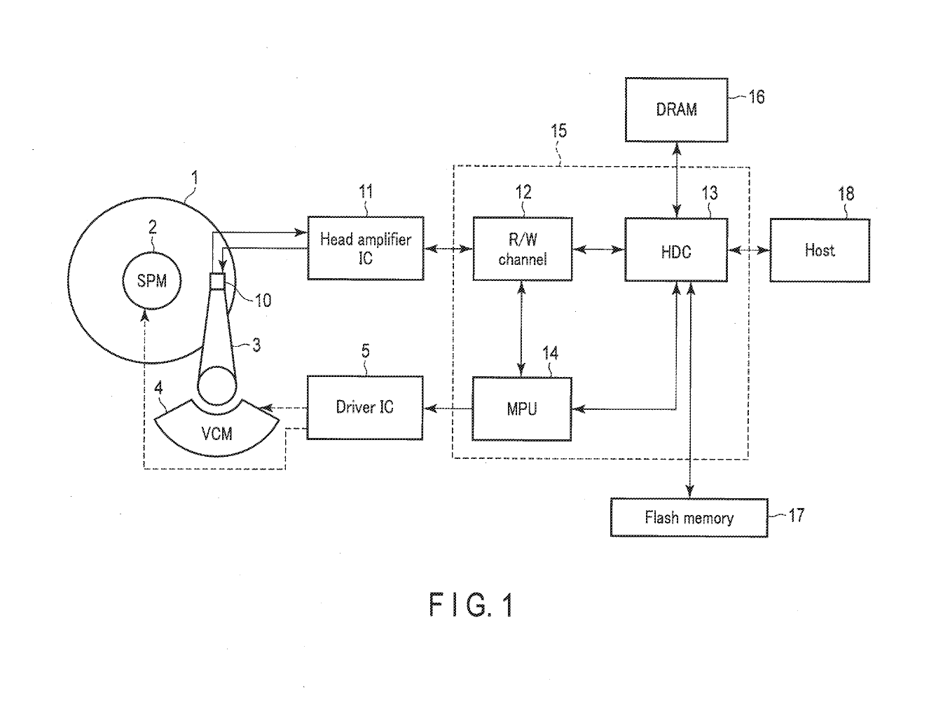

FIG. 1 is a block diagram illustrating a configuration of a hard disk drive (HDD) as a data storage apparatus of a present embodiment.

As illustrated in FIG. 1, the HDD includes a head-disk assembly (HDA) including a mechanical portions; a motor driver (driver IC) 5; a head amplifier integrated circuit (hereinafter, as “head amplifier IC”) 11; and a system controller 15 composed of a one-chip integrated circuit.

The HDA includes a disk 1 which is a storage media, a spindle motor (SPM) 2, an arm 3 on which a head 10 is mounted, and a voice coil motor (VCM) 4. The SPM 2 and VCM 4 are driven and controlled by the driver IC 5. The disk 1 is rotated by the SPM 2. The arm 3 and VCM 4 constitute an actuator. The actuator executes, by the driving of the VCM 4, control to move the head 10 mounted on the arm 3, to a specified position on the disk 1.

The head 10 includes a slider as a main body, and includes a write head and a read head mounted on the slider. The read head reads data (servo data and user data) recorded on the disk 1. The write head writes data (user data, etc.) on the disk 1. The head amplifier IC 11 includes a read amplifier and a write driver. The read amplifier amplifies a read signal which was read by the read head, and transmits the amplified signal to a read/write (R/W) channel 12 which is included in the system controller 15. The write driver transmits to the write head a write current corresponding to write data which is output from the R/W channel 12.

The system controller (referred to simply as “controller” in some cases) 15 includes the R/W channel 12, a hard disk controller (HDC) 13, and a microprocessor (MPU) 14. The R/W channel 12 includes a write channel and a read channel. The write channel executes an encoding process of write data which is recorded on the disk 1. The read channel executes a decoding process of a read signal which was read from the disk 1.

The HDC 13 includes a host interface circuit which controls the input/output of data and commands (read command and write command) between the HDC 13 and a host 18. The HDC 13 controls data transfer between the host 18 and the R/W channel 12. The HDC 13 executes data transfer control by controlling a buffer memory which is composed of a DRAM (dynamic random access memory) 16, and temporarily storing read data and write data in the DRAM 16. In addition, the HDC 13 controls a flash memory 17, and temporarily stores data, for example, at a time of accidental power interruption. Further, the HDC 13 controls the flash memory 17, and reads out, for example, parameters relating to the read process or write process on the disk 1.

The MPU 14 cooperates with the HDC 13, and controls a read operation and write operation of data via the R/W channel 12. In addition, the MPU 14 executes utilities processing of the present embodiment. The utilities processing includes processes for securing the reliability of data on the disk 1, for instance, an Adjacent Track Interference (ATI) scan process, a Background Media Scan (BMS) process, and a Drive Self-Test (DST) process. Furthermore, the utilities processing may include formatting.

Here, in general, the utilities processing corresponds to a background process, in contrast with the read process or write process which is the main process, and there is a case in which the utilities processing accesses (or scans) the entire surface of the disk, without designating logical addresses (LBA).

In general, the formatting of the HDD includes physical formatting and logical formatting. The physical formatting is formatting which is executed prior to shipment of the HDD, and which does not depend on an OS (operating system) of the host. The logical formatting is formatting which depends on the OS of the host. In the present embodiment, there is a case in which the utilities processing include the logical formatting.

In the meantime, for the purpose of convenience, the controller 15 of the embodiment may be configured to function as a plurality of controllers which are realized by the MPU 14 and HDC 13.

### First Embodiment

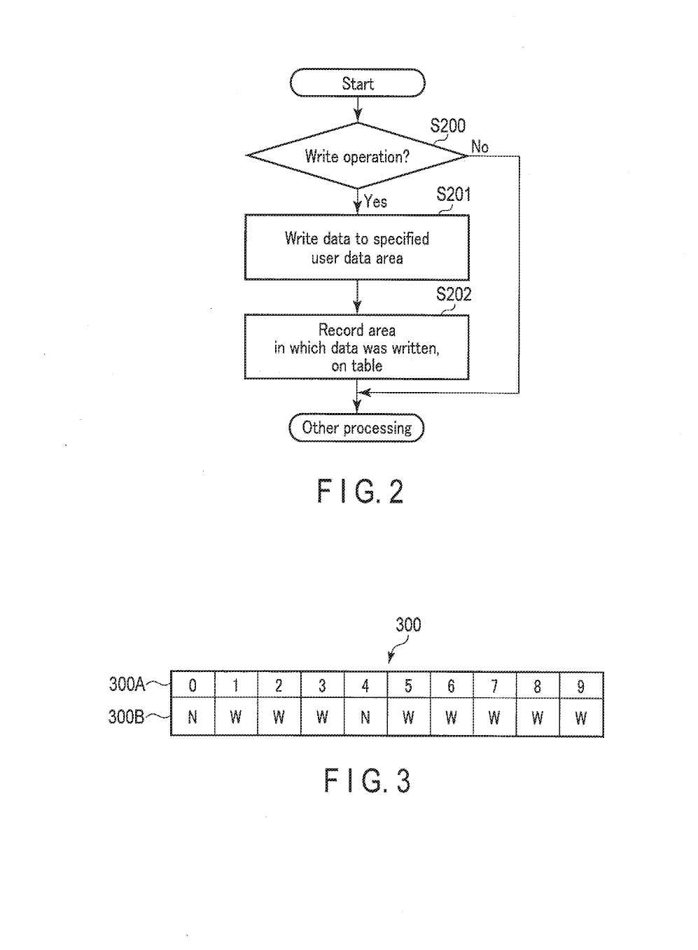

Hereinafter, referring to FIG. 2 to FIG. 5, a plurality of operations including utilities processing according to a first embodiment will be described.

FIG. 2 is a flowchart for describing a write process according to the first embodiment. FIG. 3 is a view for describing a table which is used in the utilities processing according to the first embodiment.

When the HDD is shipped, servo data is recorded on the disk 1, but user data is not written in a user data area. In the HDD which was powered on after the shipment, the MPU 14 cooperates with the HDC 13 and executes a data write process, utilities processing or a read process, responding to the reception by the HDC 13 of a command from the host 18.

As illustrated in FIG. 2, if the command received from the host 18 is a write command (Yes in S200), the MPU 14 controls a data write operation. In this case, the MPU 14 executes servo control to position the head 10 on the disk 1, and writes user data (referred to simply as “data” in some cases) to a specified user data area (S201). Here, the MPU 14 records on a table 300 (see FIG. 3) an area (written area) in which data was written, among user data areas (S202). In the meantime, in cases other than the write operation (No in S200), the MPU 14 executes other processing, such as utilities processing or a read process, as will be described later.

As illustrated in FIG. 3, the table 300 is a management table for recording flag information 300B which indicates whether data is written or not, in association with respective areas (here, No. 0 to No. 9) of a user data area 300A. Incidentally, the number of areas of the user data area 300A is not limited to 10. The flag information 300B includes flag information (W) indicative of a written area in which data is written, and flag information (N) indicative of an unwritten area in which no data is written. Here, the user data area is managed, for example, in units of a divisional recording area including a plurality of tracks which are formed on the disk 1 by formatting. Each track includes a plurality of sectors. The sector is a minimum access unit from the host 18.

In the meantime, the table 300 is stored on the flash memory 17 or disk 1. After the HDD is activated, the table 300 is temporarily stored in the DRAM 16, and is updated by the MPU 14. Besides, the information, which is managed by the table 300, may not be managed in a table form.

Here, at the time of shipment of the HDD, since all areas of the user data area are in the state of unwritten areas, flag information (N) is recorded in all areas of the user data area 300A. After the shipment of the HDD, when formatting (logical formatting) is executed as utilities processing, the utilities processing on the areas, in which flag information (N) is recorded, is skipped in the first embodiment. On the other hand, conventionally, a purpose-specific table is not prepared, nor is the management of flag information implemented. All areas of the user data area are targets of formatting.

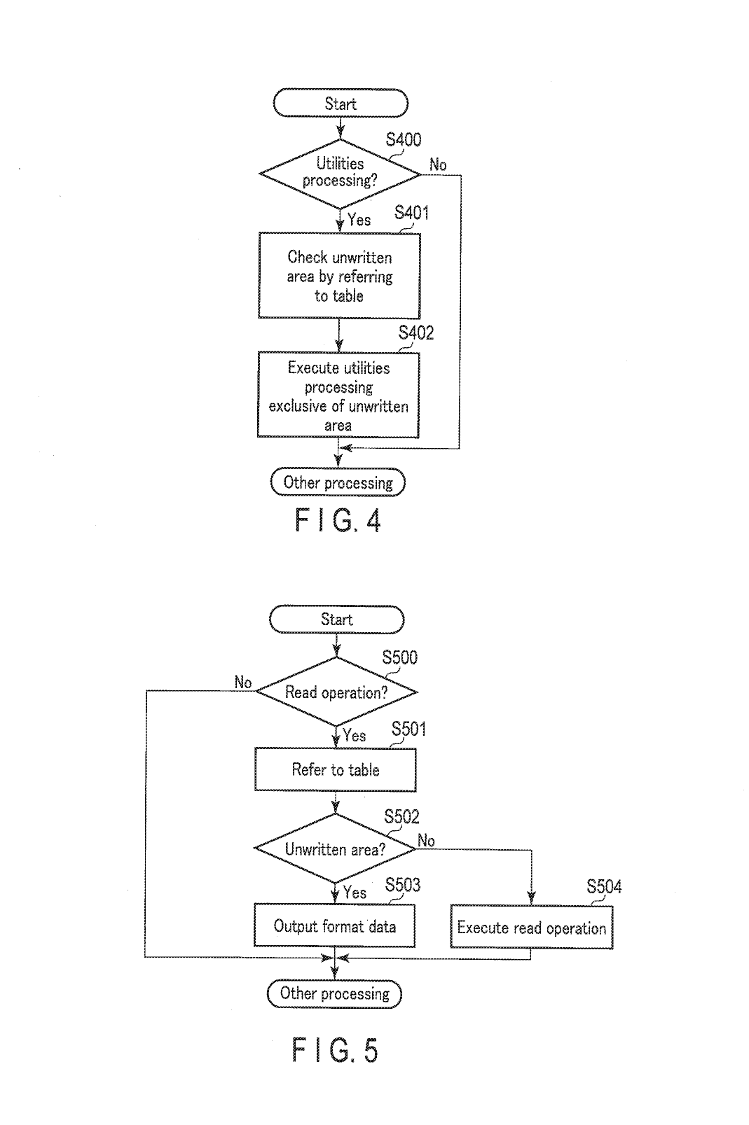

FIG. 4 is a flowchart for describing the utilities processing according to the first embodiment.

As illustrated in FIG. 4, the MPU 14 executes utilities processing, for example, when a specific command was received from the host 18, or at an arbitrary time (Yes in S400). Here, “arbitrary time” includes, for example, a time immediately after power-on, and a time excluding a time of a read operation or write operation. When the MPU 14 executes the utilities processing, the MPU 14 refers to the table 300, and checks and recognizes a divisional recording area (unwritten area) in which no data is written (S401).

Next, the MPU 14 executes the utilities processing on, as targets, written areas in which data is written, exclusive of the divisional recording areas of the unwritten areas, in the user data area 300A on the disk 1 (S402). Specifically, the MPU 14 refers to the table 300, and skips the utilities processing on the divisional recording areas (No. 0 and No. 4) corresponding to the flag information (N) indicative of unwritten areas in the user data area 300A. On the other hand, the MPU 14 executes the utilities processing on the divisional recording areas (Nos. 1-3 and Nos. 5-9) corresponding to the flag information (W) indicative of written areas in the user data area 300A. In the meantime, after the utilities processing is completed, or when the utilities processing is not executed (No in S400), the MPU 14 executes other processing, such as the above-described write process or a read process which will be described later.

FIG. 5 is a flowchart for describing the read process according to the first embodiment.

If the command received from the host 18 is a read command, the MPU 14 controls a data read operation (Yes in S500). The MPU 14 refers to the table 300 and checks whether a read target area is an unwritten area or not (S501, S502). If the read target area is a written area, the MPU 14 executes a read process of reading data from this area (No in S502, S504). The HDC 13 outputs the read data to the host 18.

On the other hand, if the read target area is an unwritten area (Yes in S502), the MPU 14 reads out format data, for example, from the DRAM 16, since no data is written. In the meantime, the format data is initially stored, for example, in the system area of the disk 1, and, when the HDD is activated, the format data is developed from the system area into the DRAM 16. Thereby, the HDC 13 outputs the format data as read data to the host 18 (S503). By the reception of the format data, the host 18 can recognize that the user data area of the access target is an unwritten area. Here, the format data is, for example, all-zero data. In the meantime, when the read process is not executed (No in S500), the MPU 14 executes other processing, such as the above-described write process or utilities processing.

As described above, when the utilities processing is executed, the utilities processing is executed on, as targets, only the written areas, by referring to the table 300. Accordingly, unlike the conventional art in which the entire surface of the disk 1 is accessed and the utilities processing is executed on the entire user data area, the utilities processing is executed on only the written areas as targets. Thus, the processing time of the utilities processing can be shortened. Thereby, it is possible to suppress to a minimum a decrease in performance of the data access operations (read operation and write operation) which are involved in the utilities processing. In addition, in the first embodiment, when a read access request is issued from the host with respect to the user data area of the unwritten area, formant data is returned to the host. Thereby, since a process such as an error process can be omitted, the reduction in response time to the host can be realized.

In the meantime, the utilities processing of the present embodiment may include logical formatting which is executed after the shipment of the HDD.

### Second Embodiment

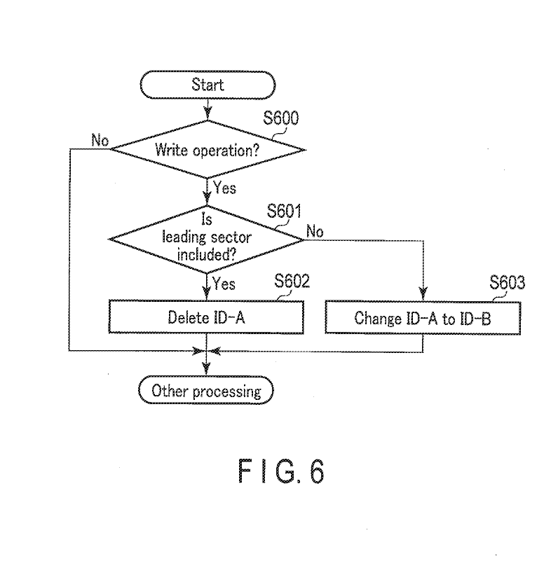

Next, referring to FIGS. 6, 7A, 7B, 8 and 9, operations including utilities processing according to a second embodiment will be described. Incidentally, in the second embodiment, too, the user data area is managed, for example, in units of a divisional recording area including a plurality of tracks which are formed on the disk 1 by formatting. Each track includes a plurality of sectors. The sector is a minimum access unit from the host 18.

FIG. 6 is a flowchart for describing a write process according to the second embodiment.

As illustrated in FIG. 6, if the command received from the host 18 is a write command (Yes in S600), the MPU 14 checks whether a leading sector of a divisional recording area is included in a user data area that is specified for write as a write target (S601).

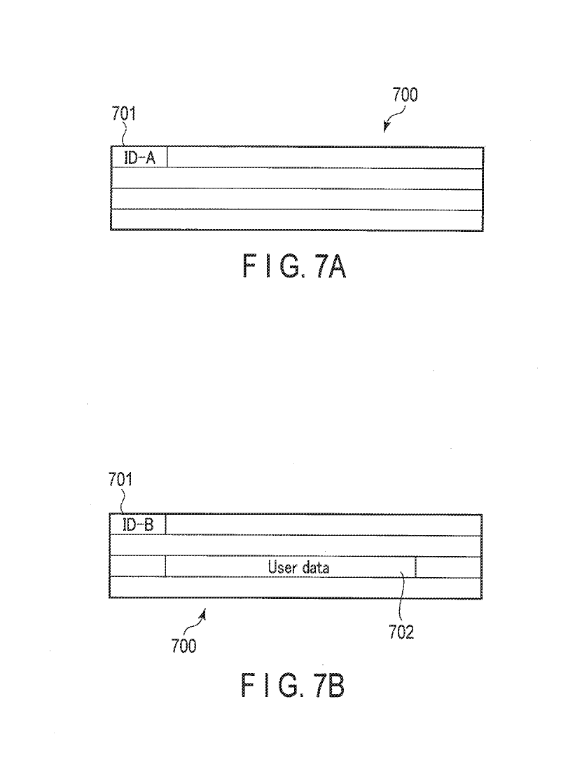

FIG. 7A and FIG. 7B are views for describing the state of a user data area 700 on the disk 1. Here, the user data area 700 is, for example, a divisional recording area including a plurality of tracks. As illustrated in FIG. 7A, at the time of shipment of the HDD, identification data ID-A is written in a leading sector 701 of the user data area 700 on the disk 1. This identification data ID-A is identification data indicating that the user data area 700 is in a state of an unwritten area. Specifically, the identification data ID-A indicates that no data is written in any of the areas (sectors other than the leading sector 701) of the user data area 700.

Referring back to FIG. 6, if the leading sector is included as a write target (Yes in S601), the MPU 14 controls a process of writing data in the area including the leading sector. Specifically, like the case of the first embodiment, the MPU 14 executes servo control to position the head 10 at a specified user data area on the disk 1, and writes data to the specified user data area. Accordingly, the identification data ID-A, which is written in the leading sector, is erased by overwrite of data (S602). Here, if formatting is executed after the shipment of the HDD, all areas of the user data area are set in the state of unwritten areas. At this time, the MPU 14 writes once again the identification data ID-A in the leading sector 701 of the user data area 700.

On the other hand, if the leading sector is not included as a write target (No in S601), the MPU 14 writes data to the specified area other than the leading sector, and writes identification data ID-B to the leading sector of the divisional recording area including the specified area (S603). Specifically, as illustrated in FIG. 7B, data is written to a specified area 702, other than the leading sector 701, in the user data area 700. In addition, the identification data ID-A, which is written in the leading sector 701 of the user data area 700, is updated to other identification data ID-B.

Specifically, the identification data, which is recorded in the leading sector 701, includes two kinds of data, namely, the identification data ID-A indicative of an unwritten area, and the identification data ID-B indicative of the presence of a written area (here, area 702) in which data was written. This identification data ID-B indicates that a written area is present, and also indicates that no user data is written in the leading sector 701. In the meantime, in cases other than the write operation (No in S600), the MPU 14 executes other processing, such as utilities processing or a read process, as will be described later.

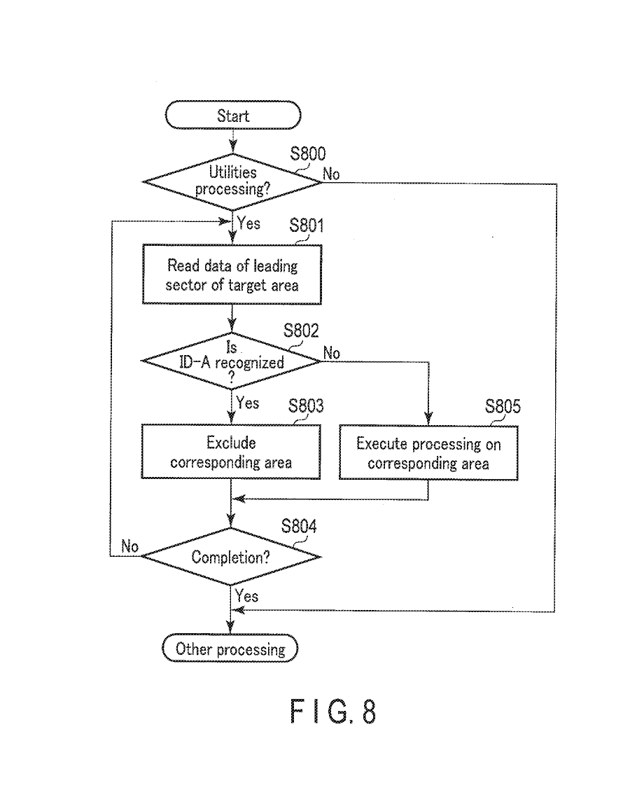

FIG. 8 is a flowchart for describing utilities processing according to the second embodiment.

As illustrated in FIG. 8, when the MPU 14 executes the utilities processing, the MPU 14 first reads data from the leading sector 701 of the user data area 700 that is the target area (Yes in S800, S801). The MPU 14 checks the data which was read from the leading sector 701, and determines whether the identification data ID-A could be recognized or not (S802). When the MPU 14 could recognize the identification data ID-A, the MPU 14 skips, and does not execute, the utilities processing on the user data area 700 (Yes in S802, S803). Specifically, the MPU 14 excludes the utilities processing on the user data area 700.

On the other hand, when the MPU 14 could not recognize the identification data ID-A, the MPU 14 executes the utilities processing on the user data area 700 (No in S802, S805). Here, also when the MPU 14 could recognize the identification data ID-B, the MPU 14 executes the utilities processing on the user data area 700.

The MPU 14 continues the process until the utilities processing on the entire user data area 700 on the disk 1 is completed (S804). In this case, based on the recognition of the identification data ID-A, the MPU 14 does not execute the utilities processing on the user data area 700 which is in the state of the unwritten area. Accordingly, unlike the conventional art, the utilities processing is not executed on the entire user data area on the disk 1, but only the written area is set as the target. Therefore, the processing time of the utilities process can be shortened. In the meantime, after the utilities processing is completed (Yes in S804), or when the utilities processing is not executed (No in S800), the MPU 14 executes other processing, such as the above-described write process or a read process which will be described later.

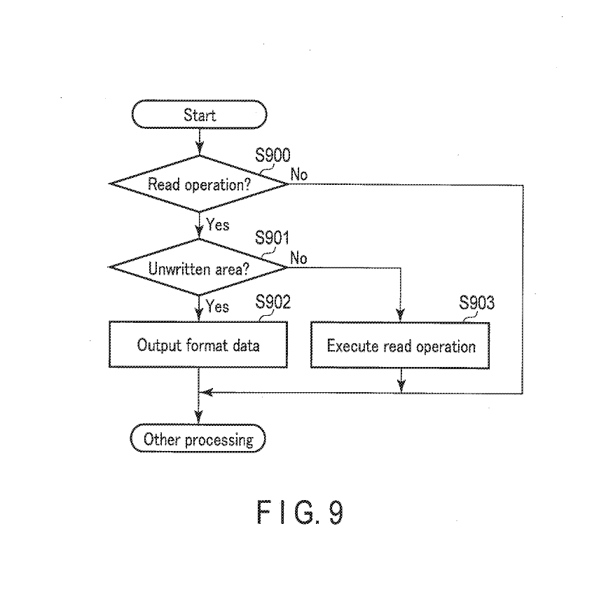

FIG. 9 is a flowchart for describing a read process according to the second embodiment.

If the command received from the host 18 is a read command, the MPU 14 controls a data read operation (Yes in S900). Based on the data which was read from the leading sector 701, the MPU 14 checks whether the user data area 700, in which read target data (target data) is recorded, is an unwritten area or not (S901). Specifically, when the MPU 14 recognized that the leading sector of this user data area 700 is the identification data ID-B or general user data, the MPU 14 determines that the user data area 700 is not an unwritten area, and that a written area exists in this area. Thereby, the MPU 14 executes a read operation of reading the target data (No in S901, S903). The HDC 13 outputs the read data to the host 18.

On the other hand, when the MPU 14 recognized that the leading sector is the identification data ID-A, the MPU 14 determines that the user data area 700 is in the state of an unwritten area (Yes in S901). When the read target area is included in the user data area 700 that is in the state of the unwritten area, the MPU 14 reads out format data, for example, from the DRAM 16, as described above, since no data is written. Thereby, the HDC 13 outputs the format data as read data to the host 18 (S902). Here, when the host 18 received the identification data ID-A from the HDC 13, the host 18 can recognize that the user data area of the access target is an unwritten area. In the meantime, when the read process is not executed (No in S900), the MPU 14 executes other processing, such as the above-described write process or utilities processing.

As described above, according to the second embodiment, the utilities processing can be executed on only the written area as a target, based on the two kinds of identification data recorded in the leading sector 701 of the user data area 700, namely, the identification data ID-A indicative of an unwritten area, and the identification data ID-B indicative of the presence of a written area. Accordingly, unlike the conventional art, the utilities processing is not executed on the entire user data area, but only the written area is set as the target. Therefore, the processing time of the utilities process can be shortened. Furthermore, according to the second embodiment, since there is no need to store the table 300 that is used in the first embodiment, the capacity of the system area of the disk 1 can be reduced.

Accordingly, also in the second embodiment, it is possible to suppress to a minimum a decrease in performance of the data access operations (read operation and write operation) which are involved in the utilities processing. In addition, also in the second embodiment, when a read access request is issued from the host with respect to the user data area of the unwritten area, formant data is returned to the host. Thereby, since a process such as an error process can be omitted, the reduction in response time to the host can be realized. In the meantime, also in the second embodiment, the utilities processing may include logical formatting which is executed after the shipment of the HDD.

As described above, according to the first and second embodiments, when the utilities processing is executed after the shipment of the HDD, the unwritten area, in which no user data is written, is recognized from the entire user data area, and the user data area of the unwritten area is excluded from the processing target. In other words, of the entire user data area, the utilities processing is executed on only the user data area that is the written area in which user data is written, or the user data area including the written area.

Accordingly, only the written area is set as the target, instead of accessing the entire surface of the disk 1 and executing the utilities processing on the entire user data area. Thus, the processing time of the utilities processing can be shortened, and the efficiency can be enhanced. Thereby, it is possible to suppress to a minimum a decrease in performance of the data access operations (read operation and write operation) which are involved in the utilities processing. In addition, in the embodiments, when a read access request is issued from the host with respect to the user data area of the unwritten area, formant data is returned to the host. Thereby, since a process such as an error process can be omitted, the reduction in response time to the host can be realized.

In the meantime, the utilities processing of the embodiments may include formatting which is executed after the shipment of the HDD.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk storage apparatus comprising:
a disk storage media; and
a controller including a host interface circuit and a processor, wherein the controller is configured to:
execute a first process of reading or writing user data from or to the disk storage media which includes a plurality of recording areas, in accordance with a command requested via the host interface, the command including address information that are capable of specifying a recording area;
recognize a first area in which no user data is written, in a case of executing a second process different from the first process on the plurality of recording areas, without designating address information that are capable of specifying a recording area; and
execute the second process on a second area in which user data is written excluding the first area among the plurality of recording areas.

2. The disk storage apparatus of claim 1, wherein the controller is configured to:
acquire information indicative of either the first area or the second area in the plurality of recording areas; and
determine, at a time of executing the second process, either the first area or the second area by referring to the acquired information.

3. The disk storage apparatus of claim 1, wherein the controller is configured to:
acquire information indicative of either the first area or the second area in the plurality of recording areas; and
update the information, when user data is written in one of the plurality of recording areas, so as to indicate that the one is the second area.

4. The disk storage apparatus of claim 1, wherein the controller is configured to:
determine, based on data read from a management area in which information indicating whether each of the plurality of recording areas is the first area or the second area are written, whether each of the recording areas is the first area or the second area.

5. The disk storage apparatus of claim 1, wherein the controller is configured to:
determine, based on data read from at least one of the plurality of recording areas, whether the at least one of the recording areas is the first area or the second area.

6. The disk storage apparatus of claim 1, wherein each of the plurality of recording areas includes a specific area for writing identification data for identifying whether at least one of the recording areas is the first area or the second area, and
wherein the controller is configured to:
determine, based on identification data read from the specific area of the at least one of the recording areas, whether the at least one of the recording areas is the first area or the second area.

7. The disk storage apparatus of claim 1, wherein at least one of the recording areas includes a specific area for writing first identification data for identifying that the at least one of the recording areas is the first area, and
wherein the controller is configured to:
overwrite second identification data indicative of the second area to a specific area included in a recording area in which data has been written; and
determine, based on the first identification data or the second identification data read from a specific area of a recording area, whether the recording area is the first area or the second area.

8. The disk storage apparatus of claim 1, wherein at least one of the recording areas includes a specific area for writing first identification data for identifying that the at least one of the recording areas is the first area, and
wherein the controller is configured to:
overwrite, in a case of writing new data into an area including a specific area in a recording area, a part of the new data on the first identification data in the specific area;
update, in a case of writing the new data to an area not including the specific area in the recording area, the first identification data in the specific area with second identification data indicative of the second area;
determine, when the first identification data is read from a specific area of a recording area, that the recording area is the first area; and
determine, when the second identification data is read, or when neither the first identification data nor the second identification data is read from a specific area of a recording area, that the recording area is the second area.

9. The disk storage apparatus of claim 8, wherein the specific area is a leading sector of the recording area.

10. The disk storage apparatus of claim 1, wherein the controller is configured to:
read data from a specified area in accordance with a command from a host; and
output predetermined format data to the host when the specified area of a read target is determined to be the first area.

11. A method of disk access controlling in a disk storage apparatus, the method comprising:
executing a first process of reading or writing user data from or to the storage media which is managed to use as a plurality of recording areas, in accordance with a command requested via the host interface, the command including addresses for specify the recording areas;
recognizing a first area in which no user data is written, in a case of executing a second process different from the first process, on the plurality of recording areas, without specifying addresses of the recording areas; and
executing the second process on a second area in which user data is written excluding the first area among the plurality of recording areas.

12. The method of claim 11, further comprising:
acquiring information indicative of either the first area or the second area in the plurality of recording areas; and
determining, at a time of executing the second process, either the first area or the second area by referring to the acquired information.

13. The method of claim 11, further comprising:
acquiring information indicative of either the first area or the second area in the plurality of recording areas; and
updating the information, when user data is written in one of the plurality of recording areas, so as to indicate that the one is the second area.

14. The method of claim 11, further comprising:
determining, based on data read from a management area in information indicating whether each of the plurality of recording areas is the first area or the second area are written, whether each of the recording areas is the first area or the second area.

15. The method of claim 11, further comprising:
determining, determine, based on data read from at least one of the plurality of recording areas, whether at least one of the recording areas is the first area or the second area.

16. The method of claim 11, wherein each of the plurality of recording areas includes a specific area for writing identification data for identifying whether at least one of the recording areas is the first area or the second area,
further comprising:
determining, based on identification data read from the specific area of at least one of the recording areas, whether at least one of the recording areas is the first area or the second area.

17. The method of claim 11, wherein at least one of the recording areas includes a specific area for writing first identification data for identifying that at least one of the recording areas is the first area,
further comprising:
overwriting second identification data indicative of the second area to a specific area included in a recording area in which data has been written; and
determining, based on the first identification data or the second identification data read from a specific area of a recording area, whether the recording area is the first area or the second area.

18. The method of claim 11, wherein at least one of the recording areas includes a specific area for writing first identification data for identifying that at least one of the recording areas is the first area, and
further comprising:
overwriting, in a case of writing new data into an area including a specific area in a recording area, a part of the new data on the first identification data in the specific area;
updating, in a case of writing the new data to an area not including the specific area in the recording area, the first identification data in the specific area with second identification data indicative of the second area;
determining, when the first identification data is read from a specific area of a recording area, that the recording area is the first area; and
determining, when the second identification data is read, or when neither the first identification data nor the second identification data is read from a specific area of a recording area, that the recording area is the second area.

19. The method of claim 18, wherein the specific area is a leading sector of the recording area

20. The method of claim 11, further comprising:
reading data from a specified area in accordance with a command from a host; and
outputting predetermined format data to the host when the specified area of a read target is determined to be the first area.
